(19) United States
(12) Patent Application Publication
(10) Pub. No.: US 2017/0111921 A1
(43) Pub. Date: Apr. 20, 2017

(54) METHOD AND APPARATUS FOR REQUESTING SCHEDULING

(71) Applicant: Telefonaktiebolaget L M Ericsson (publ), Stockholm (SE)

(72) Inventors: Rui FAN, Beijing (CN); Qianxi LU, Beijing (CN); Mattias TAN BERGSTRÖM, Stockholm (SE)

(21) Appl. No.: 14/907,468

(22) PCT Filed: Jan. 18, 2016
(86) PCT No.: PCT/CN2016/071237

§ 371 Date: Jan. 25, 2016

(30) Foreign Application Priority Data
Apr. 9, 2015 (CN) PCT/CN2015/076136

(51) Int. Cl. H04W 72/12

(52) U.S. Cl. CPC H04W 72/1242; H04W 72/1284; H04W 88/08

(57) ABSTRACT

A method and apparatus for a terminal device to request scheduling in a communication network. The terminal device may determine a priority of information to be transmitted from the terminal device to a base station of the communication network. The terminal device may transmit a scheduling request to the base station, wherein the scheduling request indicates the determined priority. In this way, in addition to the intention of the transmission of the terminal device, characteristics of the information to be transmitted by the terminal device may also be indicated to the base station.

### TECHNICAL FIELD

Embodiments of the present invention generally relate to the field of communications, and more particularly to a method and apparatus for requesting scheduling in a communication network.

### BACKGROUND

In a cellular communication, third Generation Partnership (3 GPP) Long Term Evolution (LTE) brings increasing demand for wireless broadband data. Many frequency bands have been licensed exclusively for cellular networks in order to meet such demand and provide seamless coverage. By careful planning and deployment of network nodes and elements in the cellular networks, high reliability of communication may be achieved. However, bandwidth requirements from users continue to increase, in particular, in traffic-prone buildings or hot spots. A concept directed to the increasing bandwidth requirements is to extend the frequency spectrum to include unlicensed spectrum, which may be efficient complements of licensed frequency.

In LTE Release 13 (Rel-13), major effort has recently been paid to the development of Further Enhancement of Carrier Aggregation (FeCA), which is concentrated on support carrier aggregation of more than five carriers. As used herein, the term “carrier” refers to a band unit, which, for example, has a bandwidth of 1.4, 3, 5, 10, 15 or 20 MHz in a LTE system. User equipment (UE) supportive of the carrier aggregation can transmit information, which includes control signaling and payload, on multiple aggregated carriers.

At present, the carrier aggregation in FeCA only relates to licensed carriers. In the aggregated licensed carriers, one carrier may be used as a primary carrier, and the others may be used as secondary carriers. When the UE wants to initiate transmission and thus requests scheduling by eNodeB (eNB), it transmits a scheduling request (SR) to the eNB on the primary carrier. Currently, it is also considered to introduce an unlicensed carrier into the carrier aggregation in FeCA in order to augment service spectrum. However, there is no SR transmission scheme in such an application scenario.

### SUMMARY

Generally, embodiments of the present invention provide an efficient solution for requesting scheduling by the base station.

In a first aspect, a method in a terminal device of a communication network is provided. The method comprises: determining a priority of information to be transmitted from the terminal device to a base station of the communication network; and transmitting a scheduling request to the base station, where the request indicates the determined priority. The corresponding computer program is also provided.

In some embodiments, transmitting the scheduling request may comprise: selecting a carrier based on the determined priority; and transmitting the scheduling request on the selected carrier.

In some embodiments, selecting a carrier based on the determined priority may comprise: in response to the priority being greater than a threshold, selecting a primary carrier for transmitting the scheduling request; and in response to the priority being below the threshold, selecting a secondary carrier for transmitting the scheduling request.

In some embodiments, selecting a carrier based on the determined priority may comprise: in response to the priority being greater than a threshold, selecting a licensed carrier for transmitting the scheduling request; and in response to the priority being below the threshold, selecting an unlicensed carrier for transmitting the scheduling request.

In some embodiments, the carrier may be selected further based on a carrier restriction.

In some embodiments, the priority of the information may be determined based on at least one of a type of the information, a waiting time before the transmission of the information and a quality requirement related to the information.

In some embodiments, the type of the information may include at least one of types of control signaling and payload.

In a second aspect, an apparatus in a terminal device of a communication network is provided. The apparatus comprising: a priority determining unit configured to determine a priority of information to be transmitted from the terminal device to a base station of the communication network; and a transmitting unit configured to transmit a scheduling request to the base station, wherein the scheduling request indicates the determined priority.

In a third aspect, a terminal device of a communication network is provided. The terminal device comprises a processor and a memory including computer executable instructions which, when executed by the processor, cause the terminal device to: determine a priority of information to be transmitted from the terminal device to a base station of the communication network; and transmit a scheduling request to the base station, wherein the scheduling request indicates the determined priority.

In a fourth aspect, a terminal device of a communication network is provided. The terminal device comprises processing means adapted to: determine a priority of information to be transmitted from the terminal device to a base station of the communication network; and transmit a scheduling request to the base station, wherein the scheduling request indicates the determined priority.

According to embodiments of the present invention, the scheduling request transmitted from the terminal device to the BS may indicate the priority of the information to be transmitted by the terminal device. In this way, characteristics of the information to be transmitted by the terminal device may be indicated to the base station. Accordingly, the transmission of a certain type of information, such as control signaling, may obtain possible guarantee of reliability.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an environment of a communication network in which embodiments of the present invention may be implemented;

FIG. 2 illustrates a flowchart of a method for requesting scheduling in accordance with one embodiment of the present invention;

FIG. 3 illustrates a block diagram of an apparatus for requesting scheduling in accordance with one embodiment of the present invention; and

FIG. 4 illustrates a simplified block diagram of an apparatus that is suitable for use in implementing embodiments of the present invention.

### DETAILED DESCRIPTION

The present invention will now be discussed with reference to several example embodiments. It should be understood that these embodiments are discussed only for the purpose of enabling those skilled persons in the art to better understand and thus implement the present invention, rather than suggesting any limitations on the scope of the present invention.

As used herein, the term “terminal device” or “user equipment” (UE) refers to any terminal having wireless communication capabilities, including but not limited to, mobile phones, cellular phones, smart phones, or personal digital assistants (PDAs), portable computers, image capture devices such as digital cameras, gaming devices, music storage and playback appliances, and any portable units or terminals that have wireless communication capabilities, or Internet appliances permitting wireless Internet access and browsing and the like. The term “base station” (BS) may be referred to as eNB, eNodeB, NodeB or base transceiver station (BTS) and the like depending on the technology and terminology used, which may configure/de-configure and activate/de-activate secondary cells and schedule resources on the secondary cells, for example. In the context of the present invention, the terms “user equipment” or “UE” and “terminal device” may be used interchangeably and the terms “base station” or “BS” and “eNodeB” or “eNB” may be used interchangeably hereinafter.

As used herein, the singular forms “a”, “an” and “the” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

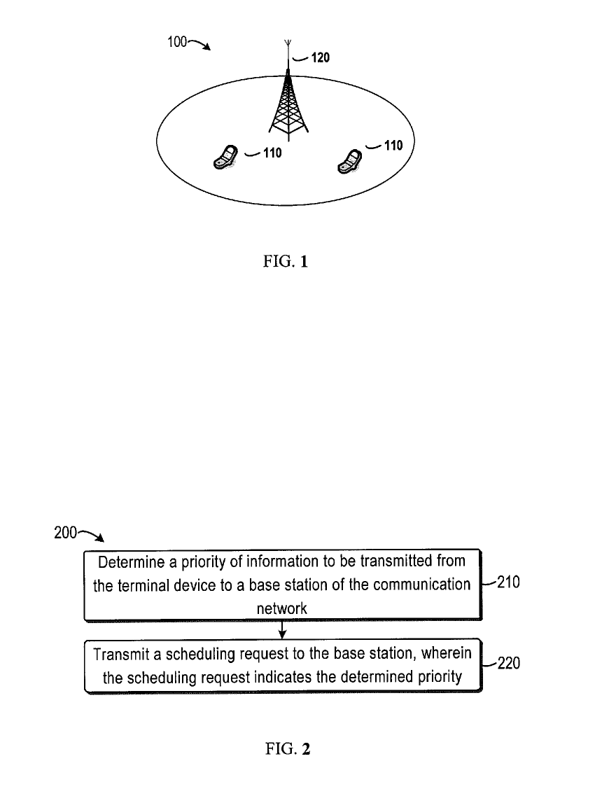

FIG. 1 shows an environment of a communication network 100 in which embodiments of the present invention may be implemented. As shown, two or more terminal devices 110 may communicate with one or more BSs 120. In this example, there are two terminal devices 110 and one BS 120. This is only for the purpose of illustration without suggesting the limitations on the number of the terminal devices 110 and the BSs 120. There may be any suitable number of the terminal devices 110 in communication with the BS 120.

The communications between the terminal devices 110 and the BS 120 may be performed according to any suitable communication protocols including, but not limited to, the first generation (1 G), the second generation (2 G), 2.5 G, 2.75 G, the third generation (3 G), the fourth generation (4 G) communication protocols, 4.5 G, and/or any other protocols either currently known or to be developed in the future.

If the terminal device 110 wants to initiate information transmission, it will transmit a SR to the BS 120. In the context of the present invention, the term “information” refers to any type of information. For example, the information may include controlling signaling and payload related to any type of traffic, such as voice traffic, data traffic, Short Messaging Service (SMS) and the like. After receiving the SR from the terminal device 110, the BS 120 may schedule the resources for the transmission of the terminal device 110, and then send a grant to the terminal device 110. Next, the terminal device 110 may transmit the information based on the scheduling by the BS 120.

In a conventional approach, an SR may only indicate that the terminal device wants to initiate the transmission and can indicate nothing else. When the BS receives the SR, the BS may be unaware of characteristics of the information to be transmitted by the terminal device, and may not offer specific scheduling for the transmission of the information.

FIG. 2 shows a flowchart of a method 200 for requesting scheduling in accordance with one embodiment of the present invention. It would be appreciated that the method 200 may be implemented in the terminal device 110 as shown in FIG. 1.

As shown, the method 200 is entered at step 210, where the terminal device 110 determines a priority of information to be transmitted to the BS 120. According to embodiments of the present invention, the priority of the information may be determined based on any suitable rules. By way of example, the priority may be determined based on information characteristics.

Specifically, in one embodiment, the priority of the information may be determined based on the type of the information. By way of example, the priority of the information may be determined based on component types of the information. As described above, the information may include controlling signaling and payload. In this example, if the information includes the control signaling, the priority of the information may be set to be high. If the information only includes payload, the priority of the information may be set to be low.

In the context of the present invention, the control signaling refers to any suitable type of control information for implementing control functions during a process of traffic, such as voice traffic, data traffic, SMS and the like. For example, in a LTE system, the control signaling may include Media Access Control (MAC) Control Element (CE), such as Power Headroom Report (PHR) and Buffer Status Report (BSR), Radio Resource Control (RRC) messages, Radio Link Control (RLC) status report and Packet Data Convergence Protocol (PDCP) control Protocol Data Unit (PDU). It should be understood that the control signaling is very important during communications because it is useful for secure, reliable and efficient delivery of the payload to a destination. As a result, the assignment of the control signaling to a high priority may enable possible specific scheduling for the control signaling by the BS, and therefore efficient communications may be achieved.

Additionally, in some embodiments, different types of control signaling may be assigned to different priorities. For example, control signaling such as a measurement report may be assigned to higher priorities because of its higher importance.

It should be appreciated that the assignment of the control signaling to the high priority is only an example. As an alternative example, the payload may be assigned to a higher priority if needed. The scope of the present invention will not be limited in this regard.

In addition to the type of the information to be transmitted, in another embodiment, the priority of the information may be determined based on a waiting time before transmission of the information. Specifically, the information may be stored in a buffer of the terminal device before being transmitted. The priority of the information may be set to be high if a time duration, for which the information has waited to be transmitted in the buffer, is greater than a time threshold.

By way of example, the time threshold for the waiting time may be associated with the delay requirement of the information. Specifically, a traffic having a strict delay requirement may use a smaller time threshold than a delay tolerant traffic. Alternatively, the time threshold may be independent of the delay requirement and set to be a predetermined threshold value for various types of traffic.

In yet another embodiment, the priority of the information may be determined on a quality requirement related to the information. As used herein, the quality requirement may refer to a transmission quality that is required during the transmission of the information, including, but not limited to, a bandwidth requirement, a bit error rate, a throughput and the like. An example indication of the quality requirement is a Quality of Service (QoS) Class Indicator (QCI). Specifically, the traffic having a higher QCI value may be assigned to a higher priority. For example, compared with the best effort traffic, the voice traffic has a higher QCI value, and therefore may be assigned to a higher priority.

According to embodiments of the present invention, the information characteristics for determining the priority of the information may be considered separately or in combination. Specifically, in one embodiment, the factors of the information characteristics as described above, such as the type of the information, the waiting time before the transmission of the information and the quality requirement related to the information, may be used together to determine the priority of the information. For example, the priority of the information may be a weighted sum of a plurality of priorities determined using respective factors.

By way of example, a score scheme may be used. Specifically, a priority score may be obtained based on each of the factors. Then, a plurality of the obtained priority scores may be summed up by respective weights. For example, regarding the type of the information, a priority score of 4 is obtained in the case of the information including a certain type of control signaling. Regarding the waiting time before the transmission of the information, a priority score of 2 is obtained in response to the information being stored in the buffer for a time duration T. Regarding the quality requirement related the information, a priority score of 3 is obtained in the case of the QCI value of X. Then, the resulting priority score of the information is a weighted sum of the three priority scores. It should be appreciated that any suitable score rules may be used when determining the priority of the information based on the score scheme. The scope of the present invention will not be limited in this regard.

Next, after the priority of the information is determined, the method 200 proceeds to step 220, where the terminal device 110 transmits a SR to the BS 120, wherein the SR indicates the determined priority. By using such an SR, in addition to the intention of the transmission of the information, the terminal device 110 can also notify the BS 120 of the priority of the information. Accordingly, the BS 120 may offer scheduling specific to the terminal device 110.

By way of example, in the case that the control signaling is assigned to a higher priority, if the terminal device 110 wants to transmit the information including the controlling signal, it will transmit an SR indicating a higher priority. Accordingly, the BS 120 may possibly offer a specific scheduling such that the transmission of the control signaling from the terminal device 110 may be effectively reliable.

According to embodiments of the present invention, the determined priority of the information may be indicated by the SR in any suitable way. Specifically, in one embodiment, the priority of the information may be indicated by the carrier for carrying the SR. For example, a carrier may correspond to a priority of information. Accordingly, an SR transmitted on a carrier may indicate a corresponding priority of the information.

As described above, in the LTE system enabling carrier aggregation, a terminal device may be allocated multiple carriers of a licensed band for transmission. Conventionally, the primary carrier from the aggregated carriers may be used by the terminal device to transmit an SR. According to embodiments of the present invention, unlicensed carriers may also be used for carrier aggregation. Accordingly, both a licensed carrier and an unlicensed carrier may act as the primary carrier or the secondary carrier. Furthermore, not only the primary carrier but also the secondary carrier may carry the SR from the terminal device 110 to the BS 120. In this way, improved coverage and reliable and efficient communications may be achieved by using unlicensed carriers as complements of licensed carriers.

In this case, in one embodiment, the terminal device 110 may select whether to use the primary carrier or the secondary carrier based on the determined priority of the information. Specifically, for example, the terminal device 110 may select the primary carrier for transmitting the SR to the BS 120 if the determined priority is greater than a threshold and otherwise select the secondary carrier. It should be appreciated that the threshold may be preset as any suitable value in implementations. The scope of the present invention will not be limited in this regard.

As an alternative example, no threshold is also possible. In this example, if the terminal device 110 has two pieces of information to be transmitted, each corresponding to one of two different priorities, it may select the primary carrier for transmitting the SR associated with the high-priority information.

In another embodiment, in addition to the primary and secondary carriers, the terminal device 110 may use licensed carriers and unlicensed carriers to indicate different priorities of the information. Specifically, if the determined priority is greater than the threshold, the terminal device 110 may select a licensed carrier for transmitting the SR, and otherwise select an unlicensed carrier. Likewise, in the case of no threshold, the terminal device 110 may select a licensed carrier for the high-priority information compared with the low-priority information.

In this embodiment, if the control signaling is assigned to a higher priority than the payload as described above, the terminal device 110 may select a licensed carrier for transmitting the information including the control signaling. It should be understood that a licensed carrier may provide a higher transmission quality than an unlicensed carrier, and that the control signaling that is essential for secure, reliable and efficient transmission of the payload. Accordingly, it is effective and efficient that the terminal device 110 selects the licensed carrier to carry an SR indicating a high priority when the information to be transmitted includes the control signaling.

According to embodiments of the present invention, the correspondence between an SR and a carrier is not unchangeable. Specifically, after a specific carrier is selected by the terminal device to carry the SR, another carrier may be used instead if needed. In one embodiment, the selection of the carrier for carrying the SR may be further based on a carrier restriction. An example of the carrier restriction may be binding of a specific type of traffic to a specific carrier. For example, some traffic having a high quality requirement, such as the voice traffic, may be tied to licensed carriers. In this example, if the terminal device 110 wants to transmit voice, it will select a licensed carrier no matter which carrier has been selected based on the priority of the information. By using the licensed carrier, a high transmission quality may be provided for the traffic having a high quality requirement. It should be appreciated that the binding of a type of traffic to a carrier is only an example of the carrier restriction without any limitation. Any other suitable carrier restrictions may be used, and the scope of the present invention will not be limited in this regard. As an alternative example, the carrier restriction may be disability of a specific carrier.

It should be appreciated that the change from the selected carrier to another carrier may be triggered by any suitable reasoning events. For example, when a licensed carrier is selected by the terminal device in response to the information including the control signaling, if the license carrier in unavailable, an unlicensed carrier may be used instead of the licensed carrier to carry the SR.

As another example, when an unlicensed carrier is selected in response to the information including no control signaling, a licensed carrier may be selected instead if the terminal device fails to listen to an unlicensed carrier. It should be understood that the licensed spectrum may be shared among communication devices. An example coexistence mechanism to operate in the licensed spectrum is Listen Before Talk (LBT). In a procedure of LBT, the terminal device listens to an unlicensed carrier before transmitting information in order to determine whether the unlicensed carrier is being used by communication devices. If the number of LBT failures exceeds a threshold limit, the terminal device may determine that it fails to listen to the unlicensed carrier.

It should be appreciated that it is only an example to use a carrier for carrying an SR to indicate the priority of the information to be transmitted from the terminal device 110 to the BS 120. Any other suitable indication may be used. For example, in another embodiment, the SR may be expanded to include one dedicated bit to indicate the priority of the information.

The SR indicating the priority of the information to be transmitted from the terminal device may enable the BS to know the priority of the information in addition to the intention of the transmission of the terminal device. As described above, in a conventional approach, the SR can only indicate to the BS that the terminal device wants to initiate the transmission of the information, but indicate nothing else. According to embodiments of the present invention, the SR is more efficient and can indicate to the BS the priority of the information to be transmitted by the terminal device, such that the BS may offer possible scheduling specific to the terminal device.

As described above, after the BS 120 receives the SR from the terminal device 110, it may schedule the resources for the transmission of the terminal device 110. According to embodiments of the present invention, in response to an SR indicating the priority of the information to be transmitted by the terminal device, the BS may flexibly determine whether to offer scheduling specific to the terminal device based on the priority of the information. For example, the BS may schedule resources on licensed carriers for the transmission of the terminal device in the case of a high priority. Optionally, in this case, the BS may also grant an unlicensed carrier to the terminal device if needed. Specifically, if there are no resources on the licensed carrier, the BS may grant the unlicensed carrier. Likewise, in the case of a low priority, the BS may optionally schedule resources on a licensed carrier to the terminal device if the resources on licensed carriers are unavailable.

As described above, after the BS schedules the resources for the transmission of the terminal device, the BS may send a grant to the terminal device. Then, the terminal device may transmit the information based on the scheduling by the BS. According to embodiments of the present invention, the transmission of the terminal device based on the scheduling is also flexible. For example, when the BS allocates resources on the licensed carrier for the transmission of the control signaling having a high priority, the terminal device may transmit the control signaling on the allocated licensed carrier after receiving from the BS a grant for the licensed carrier. Optionally, the terminal device may transmit the control signaling on an unlicensed carrier in response to no resources on the licensed carrier. Likewise, when the BS allocates resources on an unlicensed carrier for the payload having a low priority, the terminal device may optionally transmit the payload on a licensed carrier if it fails to listen to the unlicensed carrier. In this way, the process of the transmission of the terminal device may be effectively and efficiently performed.

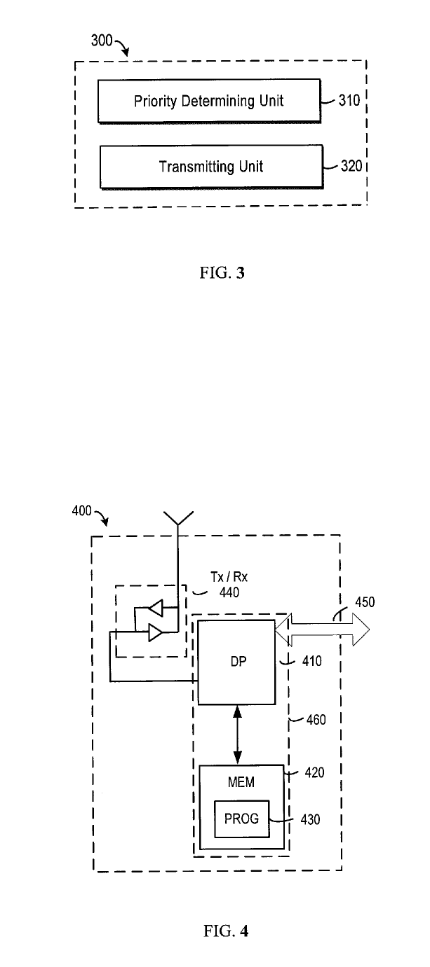

FIG. 3 shows a block diagram of an apparatus 300 for requesting scheduling in accordance with one embodiment of the present invention. It would be appreciated that the apparatus 300 may be implemented by the terminal device 110 as shown in FIG. 1.

As shown, the apparatus 300 comprises a priority determining unit 310 and a transmitting unit 320. The priority determining unit 310 is configured to determine a priority of information to be transmitted from the terminal device to the base station. The transmitting unit 320 is configured to transmit a scheduling request to the base station, wherein the scheduling request indicates the determined priority

In one embodiment, the transmitting unit 320 may comprise a carrier selecting unit configured to select a carrier based on the determined priority and a first transmitting unit configured to transmit the scheduling request on the selected carrier.

In one embodiment, the carrier selecting unit may be further configured to in response to the priority being greater than a threshold, select a primary carrier for transmitting the scheduling request; and in response to the priority being below the threshold, select a secondary carrier for transmitting the scheduling request. Alternatively or additionally, in one embodiment, the carrier selecting unit may be further configured to in response to the priority being greater than a threshold, select a licensed carrier for transmitting the scheduling request; and in response to the priority being below the threshold, select an unlicensed carrier for transmitting the scheduling request. Alternatively or additionally, in one embodiment, the carrier may be selected further based on a carrier restriction.

In one embodiment, the priority of the information may be determined based on at least one of a type of the information, a waiting time before the transmission of the information and a quality requirement related to the information. The type of the information may include at least one of types of control signaling and payload.

It should be appreciated that units included in the apparatus 300 correspond to the steps of the method 200. Therefore, all operations and features described above with reference to FIG. 2 are likewise applicable to the units included in the apparatus 300 and have similar effects. For the purpose of simplification, the details will be omitted.

The units included in the apparatus 300 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatus 300 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

FIG. 4 illustrates a simplified block diagram of an apparatus 400 that is suitable for use in implementing embodiments of the present invention. The apparatus 400 may be implemented in the terminal device 110 as shown in FIG. 1.

As shown in FIG. 4, the apparatus 400 includes a data processor (DP) 410, a memory (MEM) 420 coupled to the DP 410, a suitable RF transmitter TX and receiver RX 440 coupled to the DP 410, and a communication interface 450 coupled to the DP 410. The MEM 420 stores a program (PROG) 430. The TX/RX 440 is for bidirectional wireless communications. Note that the TX/RX 440 has at least one antenna to facilitate communication, though in practice an Access Node mentioned in this application may have several ones. The communication interface 450 may represent any interface that is necessary for communication with other network elements, such as X2 interface for bidirectional communications between eNBs, S1 interface for communication between a Mobility Management Entity (MME)/Serving Gateway (S-GW) and the eNB, or Un interface for communication between the eNB and a relay node (RN). The apparatus 400 may be coupled via a data path to one or more external networks or systems, such as the internet, for example. The Serving Gateway may be the L-GW and the eNB may be the Access Node.

The PROG 430 is assumed to include program instructions that, when executed by the associated DP 410, enable the apparatus 400 to operate in accordance with the embodiments of the present invention, as discussed herein with the method 200 in FIG. 2.

The embodiments herein may be implemented by computer software executable by the DP 410 of the apparatus 400, or by hardware, or by a combination of software and hardware.

A combination of the data processor 410 and MEM 420 may form processing means 460 adapted to implement various embodiments of the present invention.

The MEM 420 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the apparatus 400, there may be several physically distinct memory modules in the apparatus 400. The DP 410 may be of any type suitable to the local technical environment, and may include one or more of general purpose computers, special purpose computers, microprocessors, digital signal processors (DSPs) and processors based on multicore processor architecture, as non-limiting examples. The apparatus 400 may have multiple processors, such as an application specific integrated circuit chip that is slaved in time to a clock which synchronizes the main processor.

Generally, various embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present invention can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this invention, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present invention, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present invention has been described in language specific to structural features and/or methodological acts, it is to be understood that the present invention defined in the appended claims is not necessarily limited to the specific features or acts described above. Rather, the specific features and acts described above are disclosed as example forms of implementing the claims.

1. A method in a terminal device of a communication network comprising:
determining a priority of information to be transmitted from the terminal device to a base station of the communication network and
transmitting a scheduling request to the base station: wherein the scheduling request indicates the determined priority.

2. The method according to claim 1, wherein the transmitting the scheduling request comprises:
selecting a carrier based on the determined priority; and
transmitting the scheduling request on the selected carrier.

3. The method according to claim 2, wherein the selecting the carrier based on the determined priority comprises:
in response to the priority being greater than a threshold, selecting a primary carrier for transmitting the scheduling request; and
in response to the priority being below the threshold, selecting a secondary carrier for transmitting the scheduling request.

4. The method according to claim 2, wherein the selecting the carrier based on the determined priority comprises:
in response to the priority being greater than a threshold, selecting a licensed carrier for transmitting the scheduling request; and
in response to the priority being below the threshold, selecting an unlicensed carrier for transmitting the scheduling request.

5. The method according to claim 1, wherein the transmitting the scheduling request comprises:
selecting a carrier based on the determined priority and further based on a carrier restriction: and transmitting the scheduling request on the selected carrier.

6. The method according to claim 1, wherein the priority of the information is determined based on at least one of a type of the information, a waiting time before the transmission of the information and a quality requirement related to the information.

7. The method according to claim 6, wherein the type of the information includes at least one of types of control signaling and payload.

8. An apparatus in a terminal device of a communication network, comprising:
a priority determining unit, configured to determine a priority of information to be transmitted from the terminal device to a base station of the communication network; and
a transmitting unit configured to transmit a scheduling request to the base station, wherein the scheduling request indicates the determined priority.

9. The apparatus according to claim 8, wherein the transmitting unit comprises:
a carrier selecting unit configured to select a carrier based on the determined priority; and
the transmitting unit configured to transmit the scheduling request on the selected carrier.

10. The apparatus according to claim 9, wherein the carrier selecting unit is further configured to:
in response to the priority being greater than a threshold, select a primary carrier for transmitting the scheduling request; and
in response to the priority being below the threshold, select a secondary carrier for transmitting the scheduling request.

11. The apparatus according to claim 9, wherein the carrier selecting unit is further configured to:
in response to the priority being greater than a threshold, select a licensed carrier for transmitting the scheduling request; and
in response to the priority being below the threshold, select an unlicensed carrier for transmitting the scheduling request.

12. The apparatus according to claim 8,
wherein the transmitting unit comprises:
a carrier selecting unit configured to select a carrier based on the determined priority and further based on a carrier restriction; and
the transmitting unit configured to transmit the scheduling request on the selected carrier.

13. The apparatus according to claim 8, wherein the priority of the information is determined based on at least one of a type of the information, a waiting time before the transmission of the information and a quality requirement related to the information.

14. The apparatuses according to claim 13, wherein the type of the information includes at least one of types of control signaling and payload.

15. A terminal device; of a communication network-comprising:
a processor; and
a non-transitory memory containing computer-executable instructions which, when executed by the processor, cause the terminal device to:
determine a priority of information to be transmitted from the terminal device to a base station of the communication network; and
transmit a scheduling request to the base station, wherein the scheduling request indicates the determined priority.

16. The terminal device according to claim 15, wherein the computer-executable instructions, when executed by the processor, further causes the terminal device to:
select a carrier based on the determined priority; and
transmit the scheduling request on the selected carrier.

17. The method according to claim 2, wherein the carrier is selected further based on a carrier restriction.

18. The method according to claim 3, wherein the carrier is selected further based on a carrier restriction.

19. The method according to claim 4, wherein the carrier is selected further based on a carrier restriction.

20. The apparatus according to claim 9, wherein the carrier is selected further based on a carrier restriction.

21. The apparatus according to claim 10, wherein the carrier is selected further based on a carrier restriction.

22. The apparatus according to claim 11, wherein the carrier is selected further based on a carrier restriction.
